(19) United States
(12) Patent Application Publication
(10) Pub. No.: US 2006/0158714 A1
(43) Pub. Date: Jul. 20, 2006

(54) Wire fixing member and display device having the same

(76) Inventor: Jeoung-Gwen Lee, Suwon-si (KR)

Correspondence Address: CANTOR COLBURN, LLP, 55 GRIFFIN ROAD SOUTH, BLOOMFIELD, CT, 06002, US

(21) Appl. No.: 11/322,642

(22) Filed: Dec. 30, 2005

(30) Foreign Application Priority Data
Dec. 30, 2004 (KR) 2004-116726

(51) Int. Cl. G02B 26/02

(52) U.S. Cl. 359/227

(57) ABSTRACT

A display device includes a backlight assembly and a display panel. The backlight assembly includes a receiving container, a light source assembly including a light source disposed in the receiving container to generate light and power applying wires providing the light source with power, and a wire fixing member including a guiding member having a body disposed on an outer surface of the receiving container and guiding grooves formed on the body part to receive the power applying wires, and a cover covering the guiding groove. The display panel is received by the receiving container to display images using the light.

### CROSS-REFERENCE TO RELATED APPLICATIONS

This application claims priority to Korean Patent Application No. 2004-116726 filed on Dec. 30, 2004 and all the benefits accruing therefrom under 35 U.S.C. §119, and the contents of which are herein incorporated by reference in its entirety.

### BACKGROUND OF THE INVENTION

1. Field of the Invention

The present invention relates to a wire fixing member and a display device having the wire fixing member. More particularly, the present invention relates to a wire fixing member capable of guiding a wire and preventing the wire from being damaged and a display device having the wire fixing member.

2. Description of the Related Art

Generally, a liquid crystal display (LCD) device displays images using liquid crystal having an electrical characteristic such that liquid crystal molecules are rearranged by electric fields applied thereto, and having an optical characteristic such that optical transmissivity is changed by arrangement of the liquid crystal molecules.

The LCD device includes a liquid crystal controlling part that controls the arrangement of liquid crystal molecules and a light providing part that provides liquid crystal with light.

A conventional light providing part includes a light source. Examples of the light source employed by the LCD device include a cold cathode fluorescent lamp (CCFL), a light emitting diode (LED), a flat fluorescent lamp (FFL), etc.

Power is applied to the light source through a power applying wire, which causes the light source to generate light.

The power applying wire of a conventional LCD device is flexible in nature. This flexibility may make it difficult to affix the power applying wire to the LCD device without incurring damage to the power applying wire.

One solution is to fix the power applying wire to the LCD device using an adhesive member such as an adhesive tape. However, adhesives include resin material that can flow from the adhesive tape to the LCD device causing deterioration of the LCD device.

### SUMMARY OF THE INVENTION

The present invention obviates the above problems by providing a wire fixing member capable of preventing breakage or damage to the wire that supplies power to the light source.

The present invention also provides a display device including the above-mentioned wire fixing member.

In accordance with the present invention, an exemplary wire fixing member includes a guiding member and a cover. The guiding member includes a body and a guiding groove formed on an upper face of the body to receive a wire. The cover is disposed on the guiding member to have a plate shape so as to cover the guiding groove.

In accordance with an alternative exemplary embodiment of the present invention, a wire fixing member includes a guiding member, a cover and a connection part. The guiding member includes a body part having a first sidewall and a second sidewall facing the first sidewall, and a guiding groove formed on an upper face of the body part to receive a wire. The cover includes a first lateral face disposed corresponding to the first sidewall and a second lateral face disposed corresponding to the second sidewall. The cover covers the guiding groove. The connection part connects the first sidewall and the first lateral face with each other.

In accordance with still another exemplary embodiment of the present invention, a display device is provided that includes a backlight assembly and a display panel. The backlight assembly includes a receiving container, a light source assembly and a wire fixing member. The light source assembly includes a light source disposed in the receiving container to generate light and a power applying member providing the light source with power. The wire fixing member includes a guiding member having a body disposed on an outer surface of the receiving container and a guiding groove formed on the body to receive the power applying member, and a cover covering the guiding groove. The display panel is received by the receiving container to display images using the light.

According to the above, the power applying wire that is electrically connected to a light source for providing power to the light source is fixed at a predetermined position, and a cover that protects the power applying wire is disposed over the power applying wire, so that the power applying wire may be easily treated and may be prevented from disconnection and damage thereof.

### BRIEF DESCRIPTION OF THE DRAWINGS

The above and other features and advantage points of the present invention will become more apparent by describing in detailed exemplary embodiments thereof with reference to the accompanying drawings, in which:

FIG. 1 is an exploded perspective view illustrating a wire fixing member according to an exemplary embodiment of the present invention;

FIG. 2 is an exploded perspective view illustrating a wire fixing member according to another exemplary embodiment of the present invention;

FIG. 3 is a perspective view illustrating the wire fixing member shown in FIG. 2;

FIG. 4 is an exploded perspective view illustrating a wire fixing member according to still another exemplary embodiment of the present invention;

FIG. 5 is a perspective view illustrating the wire fixing member shown in FIG. 4;

FIG. 6 is an exploded perspective view illustrating a wire fixing member according to still another exemplary embodiment of the present invention;

FIG. 7 is an exploded perspective view illustrating a wire fixing member according to still another exemplary embodiment of the present invention;

FIG. 8 is a perspective view illustrating a wire fixing member according to still another exemplary embodiment of the present invention;

FIG. 9 is a perspective view illustrating a wire fixing member according to still another exemplary embodiment of the present invention;

FIG. 10 is a plan view illustrating a display device with a wire fixing member according to an exemplary embodiment of the present invention;

FIG. 11 is an exploded perspective view illustrating the wire fixing member shown in FIG. 10; and

FIG. 12 is an exploded perspective view illustrating the display device shown in FIG. 10.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like reference numerals refer to similar or identical elements throughout.

The word “wire” used in the present invention represents a conductive wire transmitting power. Alternatively, the “wire” may include a conductive wire and an insulation coating for the conductive wire. In addition, the “wire” may be a “power applying wire” or “power source wire” transmitting power to a light source.

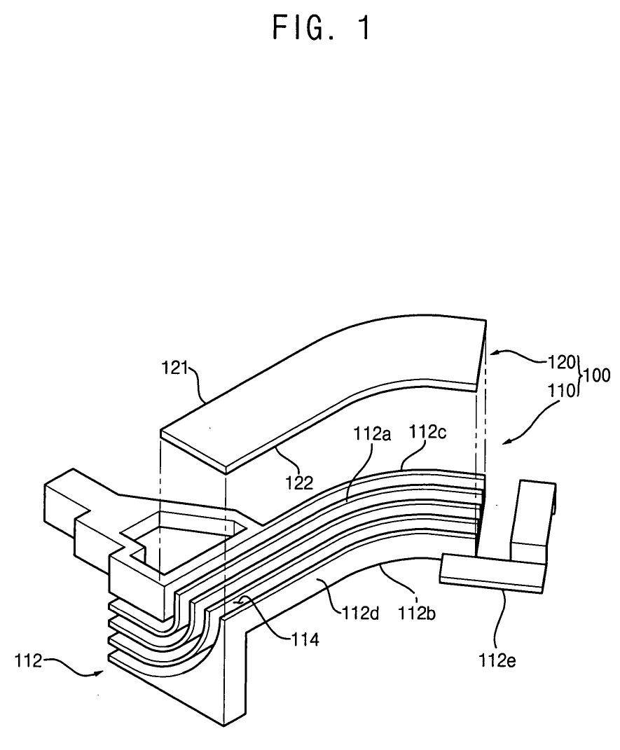

FIG. 1 is an exploded perspective view illustrating a wire fixing member according to an exemplary embodiment of the present invention.

Referring to FIG. 1, a wire fixing member 100 includes a guiding member 110 for guiding a wire in a predetermined direction, and a cover 120.

The guiding member 110 includes a body 112 and guiding grooves 114. The body 112 may be formed having an angular shape (e.g., an L-shape). The body 112 includes an upper face 112a, a bottom face 112b, a first sidewall 112c and a second sidewall 112d.

As shown in FIG. 1, guiding grooves 114 are formed at intervals on the upper face 112a. The bottom face 112b faces the upper face 112a. The first sidewall 112c connects the upper face 112a and the bottom face 112b to each other, and the second sidewall 112d faces the first sidewall 112c.

Each of the guiding grooves 114 formed on the upper face 112a has a groove shape that conforms to the shape of the body 112. The number of guiding grooves 114 employed by the wire fixing member 100 corresponds to the number of wires received by the guiding member 110 of the wire fixing member 100. In the present embodiment, there are four guiding grooves 114.

The cover 120 may be combined with the guiding member 110 using various methods for protecting the wires received by the guiding grooves 114.

The cover 120, for example, has a plate shape. The cover 120 has a first lateral face 121 and a second lateral face 122 facing the first lateral face 121. The first and second lateral faces 121 and 122 are substantially in parallel with the first and second sidewalls 112c and 112d, respectively.

The size and shape of the cover 120 may be substantially identical to the size and shape of the upper face 112a of the body 112. However, it will be understood that the cover 120 may have various other shapes such that it covers all of the guiding grooves 114. Further, the cover 120 may be disposed on the body 112 using various suitable methods.

The cover 120 protects the wires received by the guiding member 110 in a manner that it prevents the wires from disconnection and damage thereof.

A supporting part 112e may be protruded from the first sidewall 112c or second sidewall 112d to fasten the body 112, for example, to a receiving container (not shown). The supporting part 112e, for example, is extended from the first sidewall 112c of the body 112 in a direction substantially parallel with the bottom face 112b.

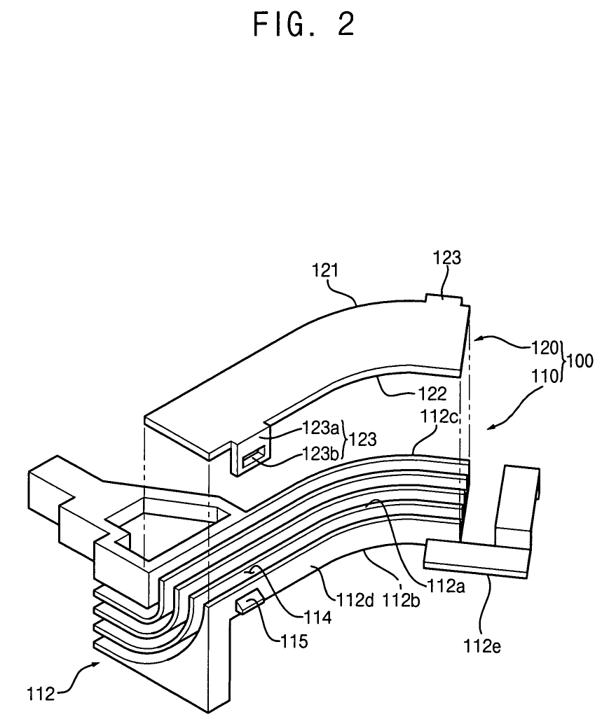

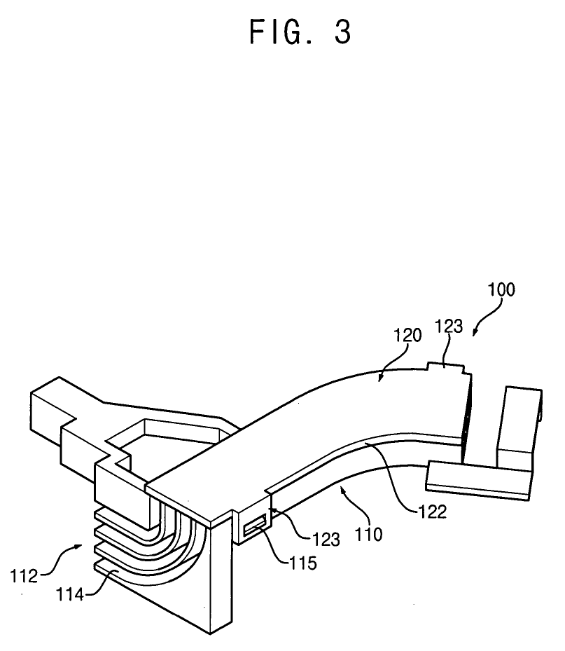

FIG. 2 is an exploded perspective view illustrating a wire fixing member according to another exemplary embodiment of the present invention. FIG. 3 is a perspective view illustrating the wire fixing member shown in FIG. 2. The wire fixing member according to the present embodiment is substantially identical to the wire fixing member in FIG. 1 except for a first fixing part and a second fixing part. Thus, any further description for the substantially same elements will be omitted.

Referring to FIGS. 2 and 3, the guiding member 110 includes a first fixing part 115, and the cover 120 includes a second fixing part 123. The first and second fixing parts 115 and 123 are coupled to each other to fix the cover 120 to the guiding member 110. In the present embodiment, the guiding member 110 includes two first fixing parts 115, and the cover 120 includes two second fixing parts 123 corresponding to the two first fixing parts 115, respectively.

The first fixing parts 115 are formed on the first sidewall 112c and the second sidewall 112d of the body 112 of the guiding member 110, respectively. The first fixing parts 115, for example, are protrusions protruded from the first sidewall 112c and the second sidewall 112d, respectively.

The second fixing parts 123 are formed on the first lateral face 121 and the second lateral face 122 of the cover 120, respectively. Each of the second fixing parts 123 includes a projected portion 123a and an opening 123b. The projected portion 123a of the second fixing part 123 formed on the first lateral face 121 is protruded from the first lateral face 121 toward the first fixing part 115 formed on the first sidewall 112c. In like manner, the projection portion 123a of the second fixing part 123 formed on the second lateral face 122 is protruded from the second lateral face 122 toward the first fixing part 115 formed on the second sidewall 112d. The opening 123b is formed on the projected portion 123a and coupled to the first fixing part 115. The opening 123b, for example, is a recess or a throughhole to be coupled with the first fixing part 115.

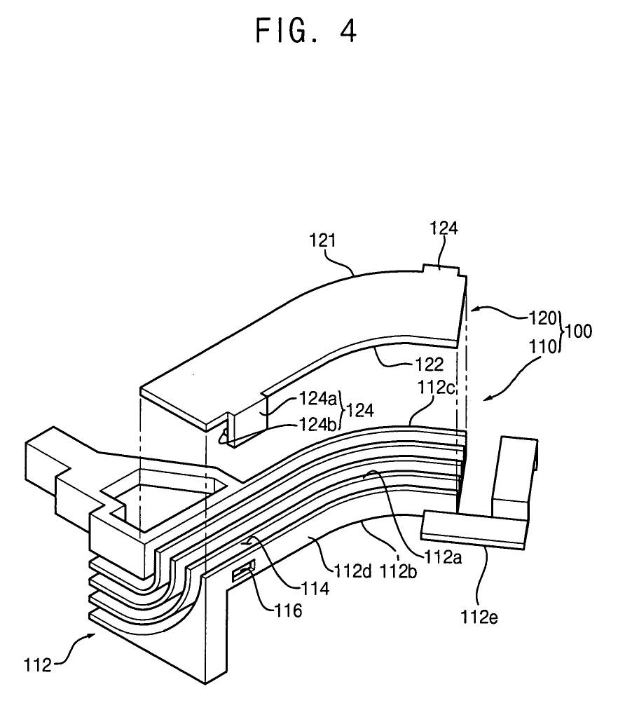

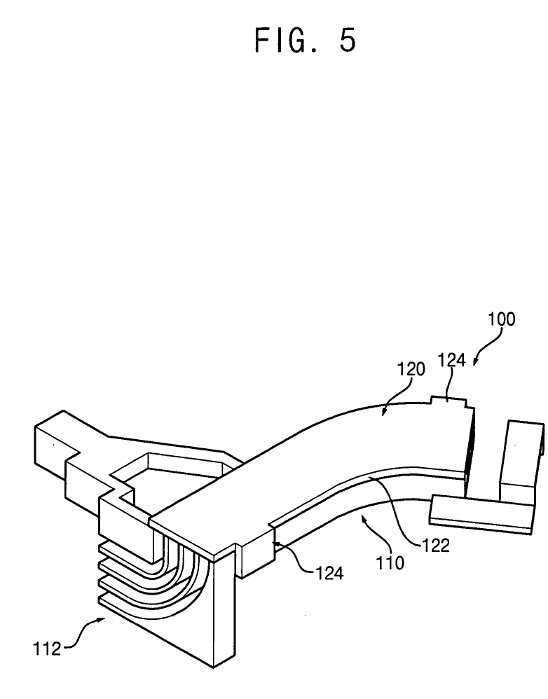

FIG. 4 is an exploded perspective view illustrating a wire fixing member according to still another exemplary embodiment of the present invention. FIG. 5 is a perspective view illustrating the wire fixing member shown in FIG. 4. The wire fixing member according to the present embodiment is substantially identical to the wire fixing member in FIG. 1 except for a first fixing part and a second fixing part. Thus, any further description for the substantially same elements will be omitted.

Referring to FIGS. 4 and 5, the guiding member 110 includes a first fixing part 116, and the cover 120 includes a second fixing part 124. The first and second fixing parts 116 and 124 are coupled to each other to fix the cover 120 to the guiding member 110. In the present embodiment, the guiding member 110 includes two first fixing parts 116, and the cover 120 includes two second fixing parts 124 corresponding to the two first fixing parts 116, respectively.

The first fixing parts 116 are formed on the first sidewall 112c and the second sidewall 112d of the body 112 of the guiding member 110, respectively. The first fixing parts 116, for example, are recesses recessed within the first sidewall 112c and the second sidewall 112d, respectively.

The second fixing parts 124 are formed on the first lateral face 121 and the second lateral face 122 of the cover 120, respectively. Each of the second fixing parts 124 includes a projected portion 124a and a protrusion 124b. The projected portion 124a of the second fixing part 124 formed on the first lateral face 121 is protruded from the first lateral face 121 toward the first fixing part 116 formed on the first sidewall 112c. In like manner, the projection portion 124a of the second fixing part 124 formed on the second lateral face 122 is protruded from the second lateral face 122 toward the first fixing part 116 formed on the second sidewall 112d. The protrusion 124b is formed on the projected portion 124a and coupled to the first fixing part 116.

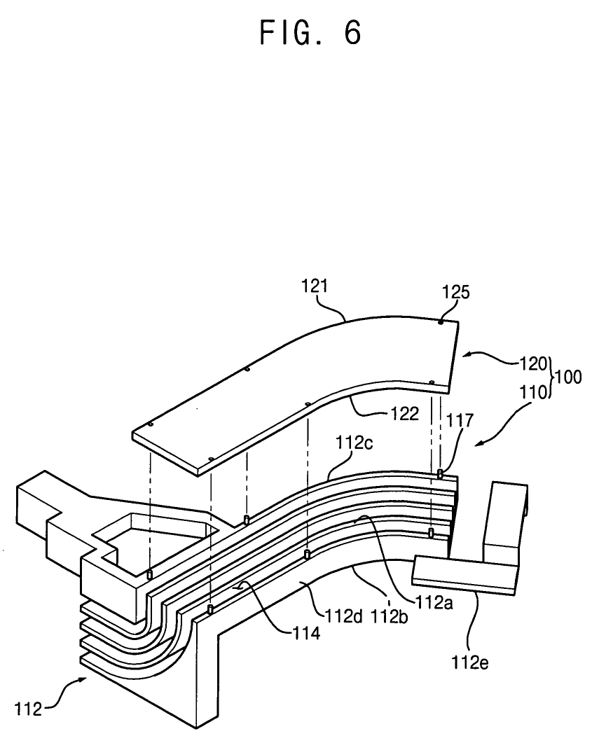

FIG. 6 is an exploded perspective view illustrating a wire fixing member according to still another exemplary embodiment of the present invention. The wire fixing member according to the present embodiment is substantially identical to the wire fixing member in FIG. 1 except for a first fixing part and a second fixing part. Thus, any further description for the substantially same elements will be omitted.

Referring to FIG. 6, the guiding member 110 includes a first fixing part 117, and the cover 120 includes a second fixing part 125. The first and second fixing parts 117 and 125 are coupled to each other to fix the cover 120 to the guiding member 110. In the present embodiment, the guiding member 110 includes six first fixing parts 117, and the cover 120 includes six second fixing parts 125 corresponding to the six first fixing parts 117, respectively. It should be noted that the number of the first and/or second fixing parts may vary in other embodiments of the present invention.

The first fixing parts 117 are formed on the upper face 112a of the body 112 of the guiding member 110. The first fixing parts 117 are spaced apart from each other. Each of the first fixing parts 117, for example, has a boss shape.

The second fixing parts 125 are formed on portions of the cover 120 respectively corresponding to the first fixing parts 117. Each of the second fixing parts 125, for example, is a recess or a throughhole coupled to a corresponding first fixing part 117.

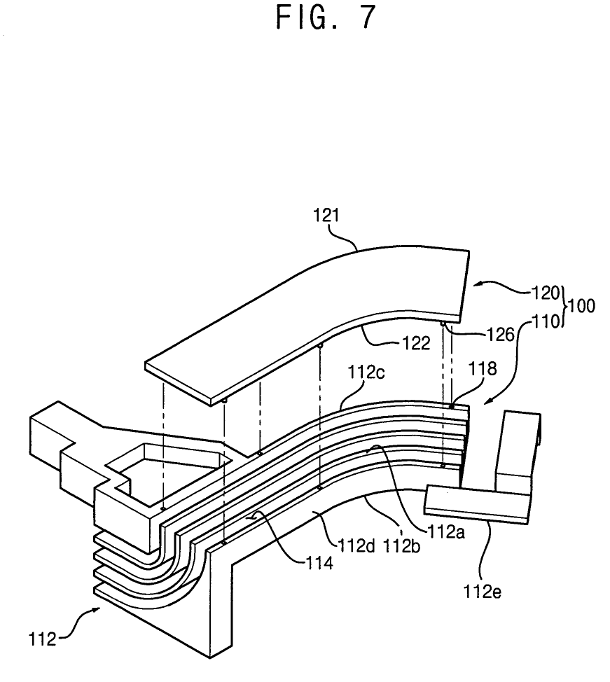

FIG. 7 is an exploded perspective view illustrating a wire fixing member according to still another exemplary embodiment of the present invention. The wire fixing member according to the present embodiment is substantially identical to the wire fixing member in FIG. 1 except for a first fixing part and a second fixing part. Thus, any further description for the substantially same elements will be omitted.

Referring to FIG. 7, the guiding member 110 includes a first fixing part 118, and the cover 120 includes a second fixing part 126. The first and second fixing parts 118 and 126 are coupled to each other to fix the cover 120 to the guiding member 110. In the present embodiment, the guiding member 110 includes six first fixing parts 118, and the cover 120 includes six second fixing parts 126 corresponding to the six first fixing parts 118, respectively. The number of the first and/or second fixing parts may vary in other embodiments of the present invention.

The first fixing parts 118 are formed on the upper face 112a of the body 112 of the guiding member 110. The first fixing parts 118 are spaced apart from each other. Each of the first fixing parts 118, for example, is a recess or a throughhole.

The second fixing parts 126 are formed on portions of the cover 120 respectively corresponding to the first fixing parts 118. Each of the second fixing parts 126, for example, is a boss coupled to a corresponding first fixing part 118.

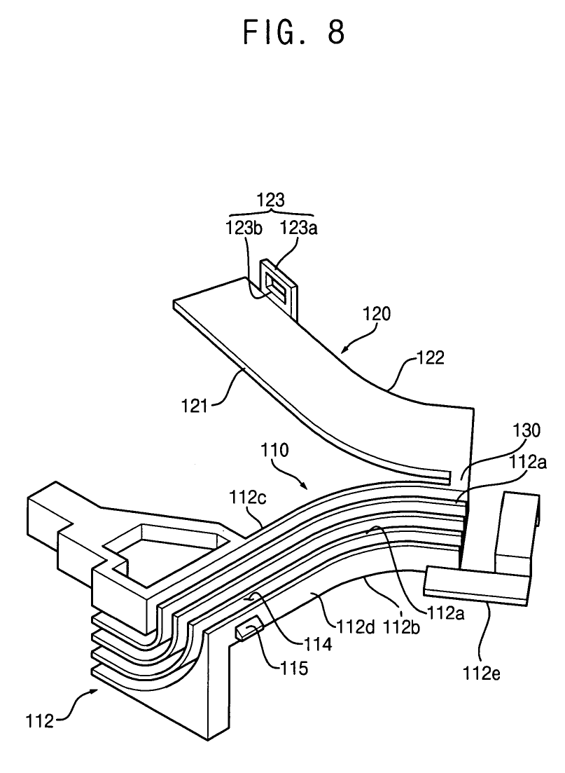

FIG. 8 is a perspective view illustrating a wire fixing member according to still another exemplary embodiment of the present invention. The wire fixing member according to the present embodiment is substantially identical to the wire fixing member in FIG. 1 except for a first fixing part, a second fixing part and a connection part. Thus, any further description for the substantially same elements will be omitted.

Referring to FIG. 8, the guiding member 110 and the cover 120 of the wire fixing member are connected to each other via a connection part 130. In particular, the first sidewall 112c of the body 112 and the first lateral face 121 of the cover 120 are connected to each other by means of the connection part 130.

The connection part 130 is integrally formed with the guiding member 110 and the cover 120, and includes a material substantially identical to that of the guiding member 110 and that of the cover 120. Alternatively, the connection part 130 may include a material different from that of the guiding member 110 and that of the cover 120.

When the connection part 130 is integrally formed with the guiding member 110 and the cover 120, an assembly process of the guiding member 110 and cover 120 may be simplified and a number of parts of the wire fixing member 100 may be reduced.

In the present embodiment, the guiding member 110 includes a first fixing part 115, and the cover 120 includes a second fixing part 123 corresponding to the first fixing part 115. Alternatively, the guiding member 110 and the cover 120 may include more than one first fixing part 115 and more than one second fixing part 123, respectively. The first fixing part 115 is formed on the second sidewall 112d of the body 112 of the guiding member 110, and the second fixing part 123 is formed on the second lateral face 122 of the cover 120 so that the cover 120 is fixed to the upper face 112a of the guiding member 110.

The first fixing part 115 may be a protrusion protruded from the second sidewall 112d.

The second fixing part 123 includes a projected portion 123a and an opening 123b. The projected portion 123a is protruded from the second lateral face 122 toward the first fixing part 115 formed on the second sidewall 112d. The opening 123b is formed on the projected portion 123a and coupled to the first fixing part 115. The opening 123b, for example, is a recess or a throughhole coupled to the first fixing part 115.

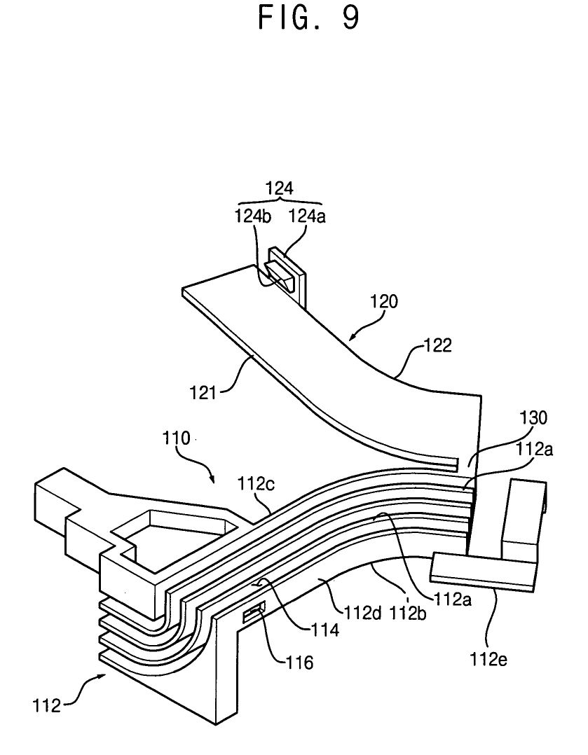

FIG. 9 is a perspective view illustrating a wire fixing member according to still another exemplary embodiment of the present invention. The wire fixing member according to the present embodiment is substantially identical to the wire fixing member in FIG. 8 except for a first fixing part and a second fixing part. Thus, any further description for the substantially same elements will be omitted.

Referring to FIG. 9, the first fixing part 116 is formed on the second sidewall 112d of the body 112 of the guiding member 110, and the second fixing part 124 is formed on the second lateral face 122 of the cover 120 so that the cover 120 is fixed to the upper face 112a of the guiding member 110.

The first fixing part 116 may be a recess recessed from the second sidewall 112d.

The second fixing part 124 includes a projected portion 124a and a protrusion 124b. The projected portion 124a is protruded from the second lateral face 122 toward the first fixing part 116 formed on the second sidewall 112d. The protrusion 124b is formed on the projected portion 124a and coupled to the first fixing part 116.

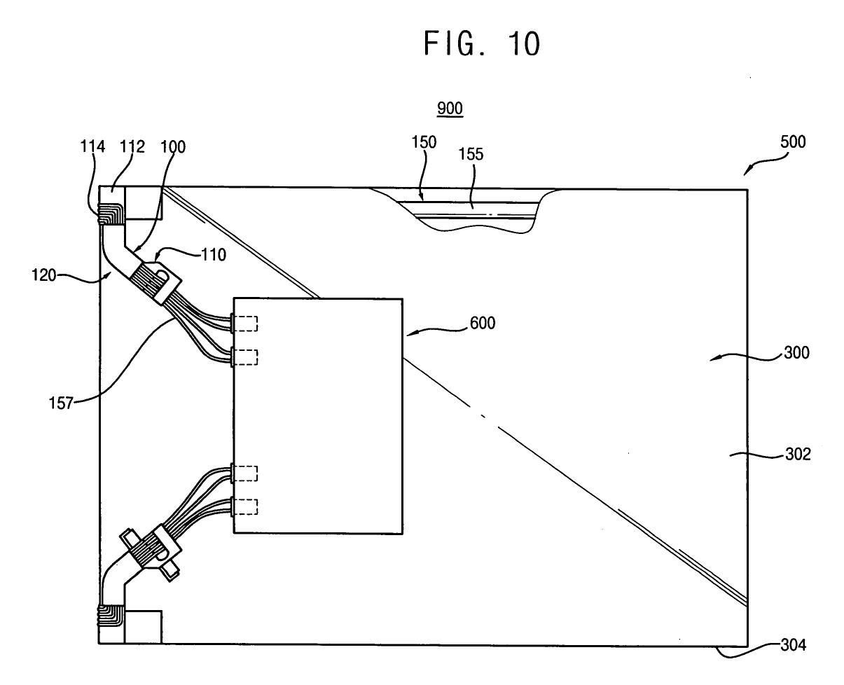

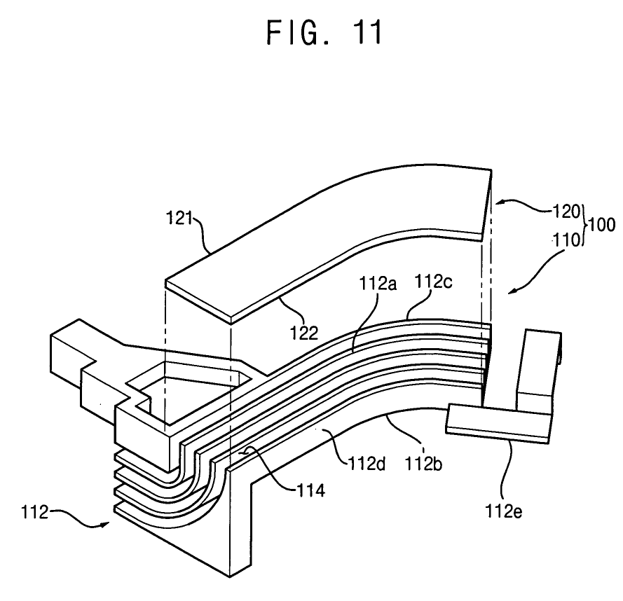

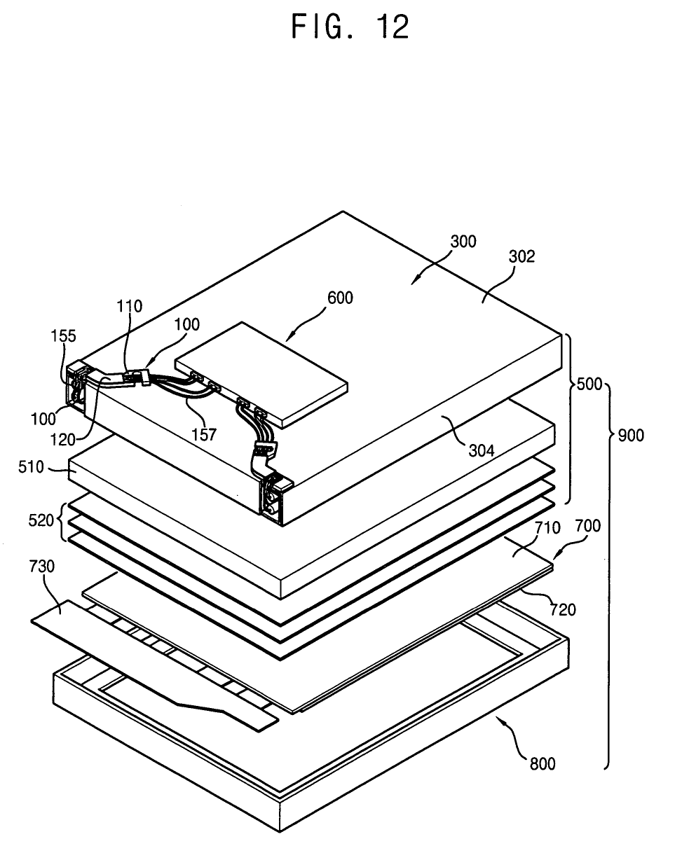

FIG. 10 is a plan view illustrating a display device including a wire fixing member according to an exemplary embodiment of the present invention. FIG. 11 is an exploded perspective view illustrating the wire fixing member shown in FIG. 10. FIG. 12 is an exploded perspective view illustrating the display device shown in FIG. 10.

Referring to FIGS. 10 to 12, display device 900 includes a backlight assembly 500, a display panel 700 and a chassis 800.

The backlight assembly 500 includes a light source assembly 150, a receiving container 300 and the wire fixing member 100. One of the embodiments in FIGS. 1-9 may be employed as the wire fixing member 100 of the backlight assembly 500.

The light source assembly 150 includes a light source 155 and power applying wires 157.

The light source 155 generates white light similar to sunlight using discharge. The light source 155, for example, includes a CCFL having heat dissipation lower than that of an incandescent electric lamp. Alternatively, the light source 155 may include a flat fluorescent lamp or an LED.

The power applying wires 157 transmit power to the light source 155. The light source 155 generates light using the power transmitted by the power applying wires 157.

In the present embodiment, the light source 155 may be implemented with a CCFL. In this case, the power applying wires 157 are electrically connected to electrodes disposed end portions of the CCFL.

The receiving container 300 receives the light source assembly 150. The receiving container 300, for example, includes a bottom plate 302 and sidewalls 304.

The bottom plate 302 of the receiving container 300, for example, has a rectangular plate shape, and the sidewalls 304 of the receiving container 300, for example, are extended from a peripheral portion of the bottom plate 302 to define a receiving space.

The light source 155 may be disposed adjacent to any one of the sidewalls 304 of the receiving container 300. Alternatively, two light sources 155 may be disposed adjacent to two sidewalls 304, respectively, which face each other.

Alternatively, four light sources 155 may be disposed adjacent to all of the sidewalls 304, respectively.

The wire fixing member 100 includes the guiding member 110 guiding the power applying wires 157 in a predetermined direction and a cover 120. The wire fixing member 100 is disposed on an outer surface of the bottom plate 302 of the receiving container 300.

The guiding member 110 includes the body 112 and the guiding grooves 114. The body 112, for example, has an L-shape. The body 112 includes the upper face 112a, the bottom face 112b, the first sidewall 112c and the second sidewall 112d.

For example, the guiding grooves 114 are formed on the upper face 112a. The bottom face 112b faces the upper face 112a, and makes contact with the outer surface of the bottom plate 302. The first sidewall 112c connects the upper face 112a and the bottom face 112b to each other, and the second sidewall 112d faces the first sidewall 112c.

Each of the guiding grooves 114 formed on the upper face 112a has a groove shape. The number of guiding grooves 114 corresponds to the number of the power applying wires 157 received by the guiding member 110. In the present embodiment, for example, the guiding member 110 includes four guiding grooves 114.

The cover 120 is combined with the guiding member 110 in various methods to protect the power applying wires 157 received by the guiding grooves 114 and to prevent the power applying wires 157 from being damaged.

The cover 120, for example, has a plate shape. The cover 120 has the first lateral face 121 and the second lateral face 122 facing the first lateral face 121. The first and second lateral faces 121 and 122 are substantially in parallel with the first and second sidewalls 112c and 112d, respectively.

The size and shape of the cover 120 may be substantially identical to the size and shape of the upper face 112a of the body 112. However, the cover 120 may have various other shapes such that it covers all of the guiding grooves 114, and may be disposed on the body 112 using various suitable methods.

The cover 120 protects the power applying wires 157 received by the guiding member 110 in a manner that it prevents the power applying wires 157 from disconnection and damage thereof.

In the present embodiment, a projected portion having a protrusion or a recess may be formed on the cover 120 of the wire fixing member 100, and either a recess corresponding to the protrusion formed on the projected portion of the cover 120 or a protrusion corresponding to the recess formed on the projected portion of the cover 120 may be formed on the guiding member 110. Thus, the cover 120 and the guiding member 110 may be combined with each other.

The power applying wires 157 fixed to the wire fixing member 100 are electrically connected to a power supplying device 600 such as an inverter disposed on the outer surface of the bottom plate 302 of the receiving container 300.

The wire fixing member 100 is fastened to the bottom plate 302 of the receiving container 300 using a fixing member. The fixing member, for example, is a screw joining the wire fixing member 100 to the receiving container 300.

The backlight assembly 500 may include a light guiding plate 510 and an optical member 520. The light guiding plate 510 is disposed inside the receiving container 300 to enhance an optical distribution of light emitted from the light source 155. The optical member 520 includes at least one of a light-diffusing plate, a light-diffusing sheet, a prism sheet, a dual brightness enhancement film (DBEF), a light-condensing film, a reflecting plate, etc. to improve optical characteristics of light emitted from the light guiding plate 510.

The display panel 700 includes a thin film transistor (TFT) substrate 710, a liquid crystal layer (not shown), a color filter substrate 720, and a driving printed circuit board (PCB) 730.

A plurality of pixel electrodes are disposed on the TFT substrate 710 in a matrix shape, and a TFT is disposed on each pixel electrode. The TFT applies signals generated from the driving PCB 730 to each pixel electrode.

The color filter substrate 720 includes a common electrode facing the pixel electrodes, and a color filter formed on a portion corresponding to each pixel electrode.

The liquid crystal layer is interposed between the TFT substrate 710 and the color filter substrate 720. Molecules of the liquid crystal layer are rearranged by electric fields generated between the pixel and common electrodes. When an arrangement of the liquid crystal molecules is changed, optical transmissivity thereof is also changed to display an image.

The chassis 800 is combined with the receiving container 300 enclosing an edge portion of the display panel 700. The chassis 800 prevents the display panel 700 from being damaged.

According to the present invention, the power applying wire that is electrically connected to a light source for providing power to the light source is fixed at a predetermined position, and the cover that protects the power applying wire is disposed over the power applying wire, so that the power applying wire may be easily treated and may be prevented from disconnection and damage thereof.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A wire fixing member comprising:
a guiding member including a body and a guiding groove formed on an upper face of the body to receive a wire; and
a cover disposed on the guiding member to cover the guiding groove.

2. The wire fixing member of claim 1, wherein the body includes a first fixing part, and the cover includes a second fixing part coupled to the first fixing part.

3. The wire fixing member of claim 2, wherein the first fixing part includes a protrusion protruded from a sidewall of the body, and the second fixing part includes an opening disposed at a position corresponding to the first fixing part, the first and second fixing parts being coupled to each other.

4. The wire fixing member of claim 3, wherein the second fixing part includes a projected portion protruded from a face of the cover toward the first fixing part, the opening being formed at the projected portion.

5. The wire fixing member of claim 2, wherein the first fixing part includes a recess formed on a sidewall of the body, and the second fixing part includes a protrusion disposed at a position corresponding to the first fixing part, the first and second fixing parts being coupled to each other.

6. The wire fixing member of claim 5, wherein the second fixing part includes a projection portion protruded from a face of the cover toward the first fixing part, the protrusion being formed at the projected portion.

7. The wire fixing member of claim 2, wherein the first fixing part includes a protrusion protruded from the upper face of the body toward the cover, and the second fixing part includes a recess formed on the cover at a position corresponding to the protrusion.

8. The wire fixing member of claim 2, wherein the first fixing part includes a recess formed on the upper face of the body, and the second fixing part includes a protrusion protruded from a face of the cover toward the upper face of the body, the protrusion being formed at a position corresponding to the recess.

9. The wire fixing member of claim 1, wherein the body includes a supporting part extended from a sidewall of the body in a direction substantially parallel with a bottom face of the body.

10. The wire fixing member of claim 1, wherein the body has an angular shape.

11. A wire fixing member comprising:
a guiding member including:
a body part having a first sidewall and a second sidewall facing the first sidewall; and
a guiding groove formed on an upper face of the body part to receive a wire;
a cover including a first lateral face and a second lateral face facing the first lateral face, the cover covering the guiding groove, the first and second lateral faces being disposed corresponding to the first and second sidewalls, respectively; and
a connection part connecting the first sidewall and the first lateral face with each other.

12. The wire fixing member of claim 11, wherein the body part includes a first fixing part formed at the first sidewall, and the cover includes a second fixing part formed at the first- lateral face, the first and second fixing parts being coupled to each other.

13. The wire fixing member of claim 12, wherein the first fixing part includes a protrusion, and the second fixing part includes a recess disposed at a position corresponding to the protrusion.

14. The wire fixing member of claim 12, wherein the first fixing part includes a recess, and the second fixing part includes a protrusion disposed at a position corresponding to the recess.

15. The wire fixing member of claim 12, wherein the first fixing part includes a protrusion protruded from the upper face of the body part, and the second fixing part includes a recess formed on the cover at a position corresponding to the protrusion.

16. The wire fixing member of claim 12, wherein the first fixing part includes a recess formed at the upper face of the body part, and the second fixing part includes a protrusion protruded from a face of the cover, the protrusion being formed at a position corresponding to the recess.

17. A display device comprising:
a backlight assembly comprising: and
a receiving container;
a light source assembly including a light source disposed in the receiving container to generate light, and a power applying member providing the light source with power; and
a wire fixing member including a guiding member having a body disposed on an outer surface of the receiving container, and a guiding groove formed on the body to receive the power applying member, and a cover covering the guiding groove;
a display panel received by the receiving container to display images using the light.

18. The display device of claim 17, wherein the body includes a first fixing part, and the cover includes a second fixing part, the first and second fixing parts being coupled to each other.

19. The display device of claim 18, wherein the first fixing part includes a protrusion formed on a sidewall of the body, and the second fixing part includes an opening coupled to the protrusion.

20. The display device of claim 18, wherein the first fixing part includes a recess formed at a sidewall of the body, and the second fixing part includes a protrusion coupled to the recess.

21. The display device of claim 17, wherein the wire fixing member further includes a connection part connecting the cover and the body.

22. The display device of claim 21, wherein the connection part is integrally formed with the cover and the body.

23. The display device of claim 18, wherein the first fixing part includes a protrusion protruded from an upper face of the body, and the second fixing part includes a recess formed on the cover at a position corresponding to the protrusion.

24. The display device of claim 18, wherein the first fixing part includes a recess formed at an upper face of the body, and the second fixing part includes a protrusion protruded from a face of the cover, the protrusion being formed at a position corresponding to the recess.
